(19) United States
(12) Patent Application Publication
(10) Pub. No.: US 2014/0241785 A1
(43) Pub. Date: Aug. 28, 2014

(54) Loose-Leaf Paper Binder Ring

(71) Applicant: David W. Burns, Charlotte, NC (US)

(72) Inventor: David W. Burns, Charlotte, NC (US)

(21) Appl. No.: 13/779,133

(22) Filed: Feb. 27, 2013

(51) Int. Cl. B42F 3/00

(52) U.S. Cl. CPC B42F 3/00
USPC 402/19

(57) ABSTRACT

A loose-leaf paper binder ring comprising a generally tubular shaped body; a first connecting end of said body arranged for releasably connecting with a complementary second connecting end for opening and closing the ring; a series of lower locking teeth being laterally spaced and extending along the length of said first connecting end; a series of upper locking teeth being laterally spaced and extending along the length of said second connecting end; whereby said upper locking teeth engage said lower locking teeth when said first connecting end is directly overlapped with said second connecting end; and, whereby a lateral displacement of said upper and lower locking teeth causes said first and second connecting ends to release.

### BACKGROUND OF THE INVENTION

1) Field of the Invention

The present invention relates to binder rings, and more particularly, to a tubular shaped binder ring for securing loose-leaf papers together.

2) Description of Related Art

The prior art is replete with various binder rings for securing papers, books, and the like together for organizational purposes. However, there are various issues with the existing designs.

One popular type of design involved a metal or plastic ring with a hinge connection pivotally carrying two rod like arm sections that interlock at their distal ends. While being versatile in its ability to bind many things and even having uses beyond binding papers, this type of ring tend to provide a very loosely connected arrangement of papers, and the hinge portion tend to tear into the eyelets of the paper and damage the sheets. The rings bend over and twist in the eyelets when placed on a flat surface, which can tend to further damage and tear the paper and does not facilitate turning of the pages as would be expected with a typical spiral bound notebook. For the average student looking to add and subtract papers from a notebook, these rings are not an ideal solution in view of these problems.

Other types of rings use connecting means that do not provide a generally smooth exterior surface to the ring. Accordingly, it can be impossible to fully turn pages over and lay flat, for example, when trying to take notes in class. Also, the projecting connecting means tend to damage the pages.

As for the typical spiral bound notebook, these do not offer any ability to easily add or remove paper, often causing students to use multiple notebooks for a single subject matter rather than being able to expand the notebook paper capacity.

Accordingly, it is an object of the present invention to provide an improved binder ring for loose-leaf paper that securely holds the pages in a bundle and allows for paper to be easily added or removed.

It is a further object of the present invention to provide an improved binder ring for loose-leaf paper with a completely smooth exterior and interior surface that avoid the problems of catching on the paper and damaging the pages.

It is a further object of the present invention to provide an improved binder ring for loose-leaf paper that allows the papers to turn easily and lay completely flat to facilitate writing on the pages without damaging the papers.

### SUMMARY OF THE INVENTION

The above objectives are accomplished according to the present invention by providing a loose-leaf paper binder ring comprising a generally tubular shaped body having a first connecting end operatively associated with a second connecting end for releasably connecting the ends, wherein the second connecting end overlaps the first connecting end when connected so that the first connecting end is disposed beneath the second connecting end to form a closed ring; a plurality of lower locking teeth carried by the first connecting end, wherein the lower locking teeth are laterally spaced to define a plurality of lower release slots between adjacent teeth on the first connecting end; a plurality of upper locking teeth carried by the second connecting end, wherein the upper locking teeth are laterally spaced to define a plurality of upper release slots between adjacent teeth on the second connecting end; whereby the upper locking teeth engage the lower locking teeth to maintain the first and second connecting ends in a connected arrangement; and, whereby a lateral displacement of the second connecting end relative to the first connecting end causes the upper locking teeth to slide into the lower release slots, and the lower locking teeth to slide into the upper release slots so that the first and second connecting ends release for opening the ring.

In a further advantageous embodiment, the binder ring includes a first teeth receiving channel disposed at the first connecting end adjacent the plurality of lower locking teeth for receiving the plurality of upper locking teeth, and a second teeth receiving channel disposed at the second connecting end adjacent the plurality of upper locking teeth for receiving the plurality of lower locking teeth.

In a further advantageous embodiment, each tooth of the plurality of lower locking teeth extends from a distal edge of the first connecting end to the first teeth receiving channel, and wherein each tooth of the plurality of upper locking teeth extends from a distal edge of the second connecting end to the second teeth receiving channel.

In a further advantageous embodiment, each tooth of both the upper and lower locking teeth tapers upward from its respective distal edge and includes a convex top surface facilitating sliding of opposing teeth overtop each other when moving the first and second connecting ends into a connected arrangement.

In a further advantageous embodiment, each tooth of the lower locking teeth includes a hook portion extending overtop at least a portion of the first teeth receiving channel, and each tooth of the upper locking teeth includes a hook portion extending overtop at least a portion of the second teeth receiving channel.

In a further advantageous embodiment, the hook portion of the lower locking teeth engages the hook portion of the upper locking teeth when in a connected arrangement to hold the ring closed.

In a further advantageous embodiment, the hook portions of the upper and lower locking teeth include complementary angled engaging surfaces, wherein sliding engagement of the angled engaging surfaces between the upper and lower locking teeth when moving to a closed arrangement directs the lower locking teeth into the second teeth receiving channel and the upper locking teeth into the first teeth receiving channel.

In a further advantageous embodiment, the distal edge of the first connecting end aligns generally flush with an interior surface of the tubular shaped body when in a connected arrangement, and the distal edge of the second connecting end aligns generally flush with an exterior surface of the tubular shaped body when in a connected arrangement.

### BRIEF DESCRIPTION OF THE DRAWINGS

The construction designed to carry out the invention will hereinafter be described, together with other features thereof. The invention will be more readily understood from a reading of the following specification and by reference to the accompanying drawings forming a part thereof, wherein an example of the invention is shown and wherein:

FIG. 1 shows a perspective view of a series of loose-leaf paper binder rings holding a plurality of sheets of paper according to the present invention;

FIG. 2 shows a perspective view of a single loose-leaf paper binder ring in an open configuration according to the present invention;

FIG. 3A shows a perspective view of the loose-leaf paper binder ring in an overlapping configuration moving from an open to a closed configuration according to the present invention;

FIG. 3B shows a perspective view of the loose-leaf paper binder ring in a closed configuration according to the present invention;

FIG. 3C shows a perspective view of the loose-leaf paper binder ring moving from a closed to an open configuration according to the present invention;

FIG. 4A shows an end view of the loose-leaf paper binder ring in a closed configuration; and,

FIG. 4B shows an end view of the loose-leaf paper binder ring in an open configuration.

The above objects and features of the invention will become more fully apparent when the following detailed description is read in conjunction with the accompanying figures and examples. However, it is to be understood that both the foregoing summary of the invention and the following detailed description are of a preferred embodiment and not restrictive of the invention or other alternate embodiments of the invention. In particular, while the invention is described herein with reference to a number of specific embodiments, it will be appreciated that the description is illustrative of the invention and is not constructed as limiting of the invention. Various modifications and applications may occur to those who are skilled in the art, without departing from the spirit and the scope of the invention.

### DETAILED DESCRIPTION OF A PREFERRED EMBODIMENT

With reference to the drawings, the invention will now be described in more detail.

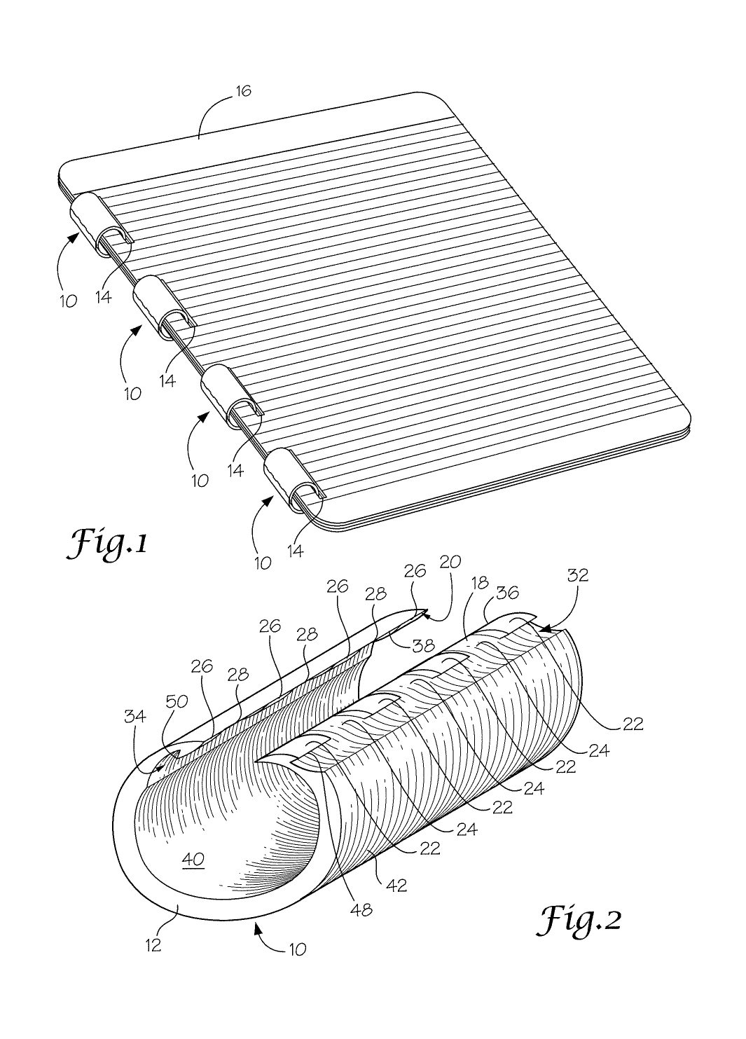

Referring to FIG. 1, a series of loose-leaf paper binder rings, designated generally as 10, are shown binding a stack of loose-leaf paper. With further reference to FIG. 2, each of binder rings 10 includes a generally tubular shaped body 12 that is received in a complementary slotted opening 14 along the edge of loose-leaf paper sheets 16. The tubular shaped body 12 helps to align and securely hold sheets 16 in a generally uniform arrangement, while the ability to open and close binder rings 10 allows for sheets to be easily added or removed. Also, as there are no exposed hinges, tabs or other jagged surface features when binder rings 10 are closed as in FIG. 1, the sheets 16 can turn easily without damage to the paper and lay completely flat to facilitate writing on the sheets.

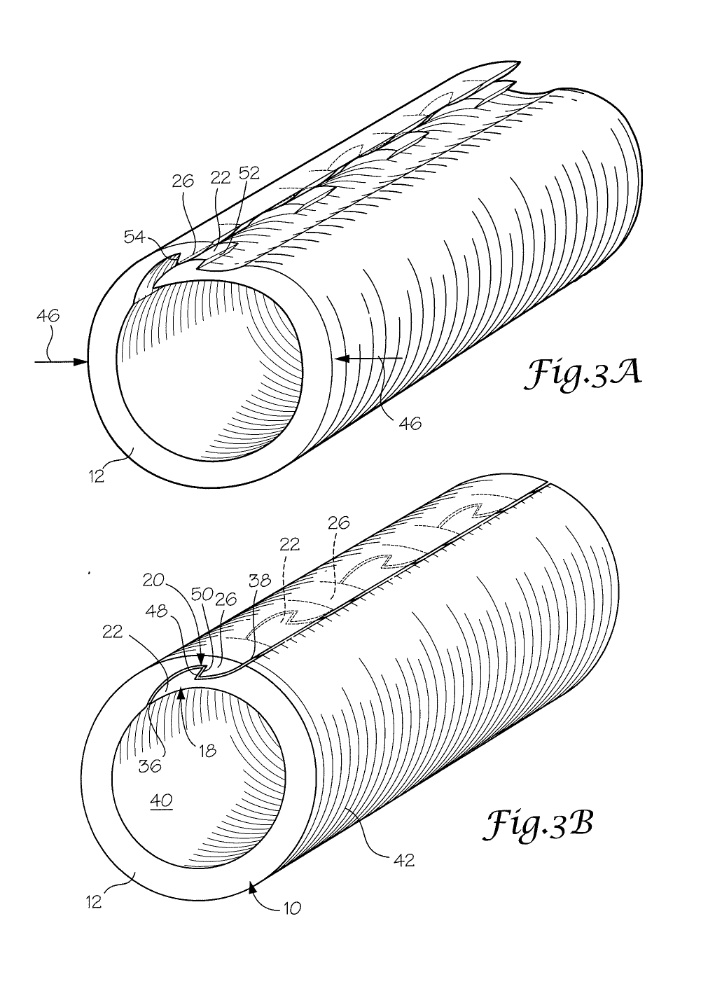

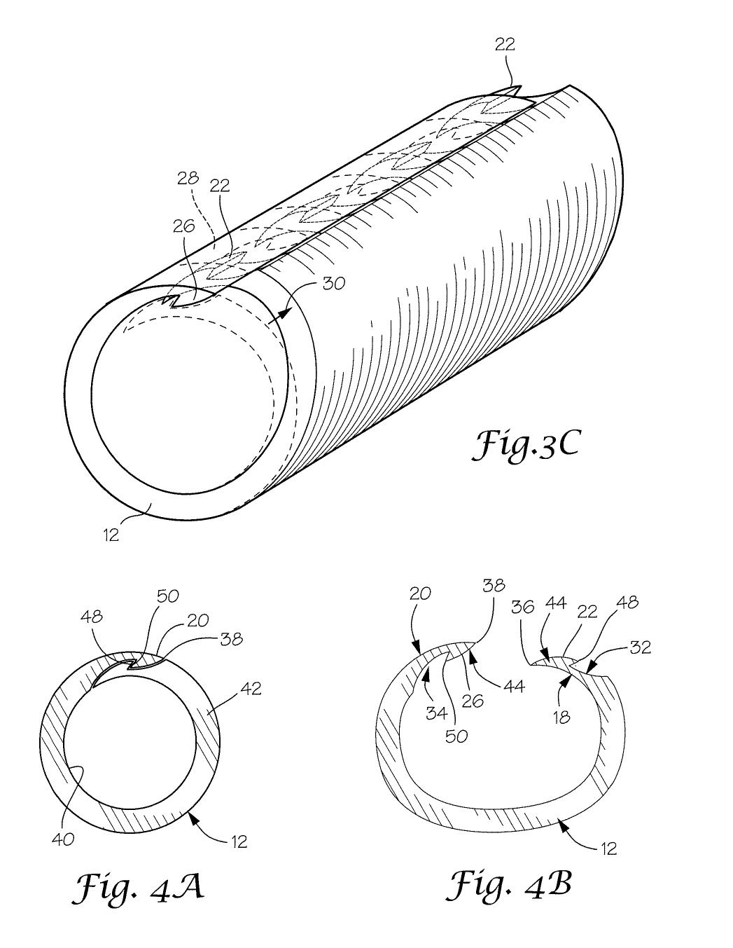

Tubular shaped body 12 includes a first connecting end 18 operatively associated with a second connecting end 20 for releasably connecting opposing ends of the body 12. With reference to FIGS. 3C and 4A, in the illustrated embodiment, second connecting end 20 overlaps first connecting end 18 when connected so that first connecting end 18 is disposed beneath second connecting end 20 to form a closed ring. The first and second connecting ends 18 and 20 could function identically in the opposite arrangement and the present invention is not limited by the configuration show by way of example in the Figures.

Referring to FIG. 2, a plurality of lower locking teeth 22 are carried by first connecting end 18. Lower locking teeth 22 are laterally spaced to define a plurality of lower release slots 24 between adjacent teeth on first connecting end 18. In a complementary arrangement for cooperating with first connecting end 18, a plurality of upper locking teeth 26 are carried by second connecting end 20. Upper locking teeth 26 are also laterally spaced to define a plurality of upper release slots 28 between adjacent teeth on second connecting end 20. With reference to FIG. 3B, when ring 10 is closed and locked, upper locking teeth 26 engage lower locking teeth 22 to maintain first and second connecting ends 18 and 20 in a connected, closed and locked arrangement.

Referring to FIG. 3C, to disconnect first and second connecting ends 18 and 20 for opening ring 10, a lateral displacement, designated by arrow 30, of second connecting end 20 relative to first connecting end 18 is required. This causes upper locking teeth 26 to slide into lower release slots 24, and lower locking teeth 22 to slide into upper release slots 28 so that first and second connecting ends 18 and 20 release. By varying number and size of interconnecting teeth on first and second connecting ends 18 and 20, and thereby the number of release slots as well, the movement required to laterally displace locking teeth 22 and 26 for opening the ring can be reduced or increased. The more locking teeth provided for a given space means that each individual tooth can be smaller, as well as the release slots between teeth, such that less lateral displacement is required to release first and second connecting ends 18 and 20.

Referring to FIGS. 2 and 4B, binder ring 10 includes a first teeth receiving channel 32 disposed at first connecting end 18 adjacent lower locking teeth 22 for receiving the plurality of upper locking teeth 26. A second teeth receiving channel 34 is disposed at second connecting end 20 adjacent the plurality of upper locking teeth 26 for receiving the plurality of lower locking teeth 22.

Referring to FIGS. 3B and 4A, second teeth receiving channel 34 allows for a distal edge 36 of first connecting end 18 to align generally flush with an interior surface 40 of tubular shaped body 12 when in a connected arrangement. Further, first teeth receiving channel 32 allows for a distal edge 38 of second connecting end 20 to align generally flush with an exterior surface 42 of the tubular shaped body 12 when in a connected arrangement. This provides for a smooth interior and exterior surface to avoid catching paper sheets 16 and damaging the paper.

Referring to FIG. 2, each tooth of the plurality of lower locking teeth 22 extends from distal edge 36 of first connecting end 18 to first teeth receiving channel 32. Further, each tooth of the plurality of upper locking teeth 26 extends from distal edge 38 of second connecting end 20 to second teeth receiving channel 34. With further Reference to FIGS. 3A and 4B, in the illustrated embodiment, each tooth of both upper and lower locking teeth 22 and 26 tapers upward from its respective distal edge 36, 38 and includes a convex top surface 44. The complementary convex top surfaces 44 facilitating sliding of opposing teeth overtop each other when moving first and second connecting ends 18 and 20 together, as indicated by direction arrows 46, into an overlapping arrangement to connect the ends together. In the illustrated embodiment, first and second teeth receiving channels 32 and 34 also include a generally concave shape complementary to convex top surface 44 of locking teeth 22 and 26 so that locking teeth 22 and 26 are received further into body 12 to promote the flush alignment of distal ends 36 and 38 with the interior and exterior surfaces 40 and 42, respectively, of body 12.

Referring to FIGS. 2 and 4B, each tooth of lower locking teeth 22 includes a hook portion 48 extending overtop at least a portion of first teeth receiving channel 32. Additionally, each tooth of the upper locking teeth 26 includes a hook portion 50 extending overtop at least a portion of second teeth receiving channel 34. Referring to FIGS. 3B and 4A, hook portion 48 of lower locking teeth 22 engages hook portion 50 of the upper locking teeth 26 when in a connected arrangement to hold connecting ends 18 and 20 closed together.

Referring to FIG. 3A, hook portions 48 and 50 include complementary angled engaging surfaces 52 and 54, respectively. Sliding engagement of angled engaging surfaces 52 and 54 between upper and lower locking teeth 22 and 26 when moving to a closed arrangement directs lower locking teeth 22 into second teeth receiving channel 34 and upper locking teeth 26 into first teeth receiving channel 32.

While a preferred embodiment of the invention has been described using specific terms, such description is for illustrative purposes only, and it is to be understood that changes and variations may be made without departing from the spirit or scope of the following claims.

What is claimed is:

1. A loose-leaf paper binder ring comprising:
a generally tubular shaped body having a first connecting end operatively associated with a second connecting end for releasably connecting said ends, wherein said second connecting end overlaps said first connecting end when connected so that said first connecting end is disposed beneath said second connecting end to form a closed ring;
a plurality of lower locking teeth carried by said first connecting end, wherein said lower locking teeth are laterally spaced to define a plurality of lower release slots between adjacent teeth on said first connecting end;
a plurality of upper locking teeth carried by said second connecting end, wherein said upper locking teeth are laterally spaced to define a plurality of upper release slots between adjacent teeth on said second connecting end;
whereby said upper locking teeth engage said lower locking teeth to maintain said first and second connecting ends in a connected arrangement; and,
whereby a lateral displacement of said second connecting end relative to said first connecting end causes said upper locking teeth to slide into said lower release slots, and said lower locking teeth to slide into said upper release slots so that said first and second connecting ends release for opening said ring.

2. The binder ring of claim 1 including a first teeth receiving channel disposed at said first connecting end adjacent said plurality of lower locking teeth for receiving said plurality of upper locking teeth, and a second teeth receiving channel disposed at said second connecting end adjacent said plurality of upper locking teeth for receiving said plurality of lower locking teeth.

3. The binder ring of claim 2 wherein each tooth of said plurality of lower locking teeth extends from a distal edge of said first connecting end to said first teeth receiving channel, and wherein each tooth of said plurality of upper locking teeth extends from a distal edge of said second connecting end to said second teeth receiving channel.

4. The binder ring of claim 3 wherein each said tooth of both said upper and lower locking teeth tapers upward from its respective distal edge and includes a convex top surface facilitating sliding of opposing teeth overtop each other when moving said first and second connecting ends into a connected arrangement.

5. The binder ring of claim 4 wherein each said tooth of said lower locking teeth includes a hook portion extending overtop at least a portion of said first teeth receiving channel, and each said tooth of said upper locking teeth includes a hook portion extending overtop at least a portion of said second teeth receiving channel.

6. The binder ring of claim 5 wherein said hook portion of said lower locking teeth engages said hook portion of said upper locking teeth when in a connected arrangement to hold said ring closed.

7. The binder ring of claim 6 wherein said distal edge of said first connecting end aligns generally flush with an interior surface of said tubular shaped body when in a connected arrangement, and said distal edge of said second connecting end aligns generally flush with an exterior surface of said tubular shaped body when in a connected arrangement.

8. A loose-leaf paper binder ring comprising:
a generally tubular shaped body;
a first connecting end of said body arranged for releasably connecting with a complementary second connecting end for opening and closing the ring;
a series of lower locking teeth being laterally spaced and extending along the length of said first connecting end;
a series of upper locking teeth being laterally spaced and extending along the length of said second connecting end;
whereby said upper locking teeth engage said lower locking teeth when said first connecting end is directly overlapped with said second connecting end; and,
whereby a lateral displacement of said upper and lower locking teeth causes said first and second connecting ends to release.

9. The binder ring of claim 8 including a series of release slots defined between adjacent teeth of said upper locking teeth and said lower locking teeth, wherein said upper locking teeth slide into said release slots between said lower locking teeth, and said lower locking teeth slide into said release slots between said upper locking teeth to release said first and second connecting ends when said lateral displacement is provided.

10. The binder ring of claim 8 including a first teeth receiving channel disposed at said first connecting end adjacent said lower locking teeth for receiving said upper locking teeth, and a second teeth receiving channel disposed at said second connecting end adjacent said upper locking teeth for receiving said lower locking teeth.

11. The binder ring of claim 8 wherein each said tooth of both said upper and lower locking teeth tapers upward from a respective distal edge of each said connecting end and includes a convex top surface facilitating sliding of opposing teeth overtop each other when moving said first and second connecting ends into a directly overlapping connected arrangement.

12. The binder ring of claim 8 wherein each said tooth of said upper and lower locking teeth includes a hook portion, wherein said hook portion of said lower locking teeth engages said hook portion of said upper locking teeth when in a connected arrangement to hold said ring closed.

13. The binder ring of claim 8 wherein a distal edge of said first connecting end aligns generally flush with an interior surface of said tubular shaped body when in a connected arrangement, and a distal edge of said second connecting end aligns generally flush with an exterior surface of said tubular shaped body when in a connected arrangement.

14. A loose-leaf paper binder ring comprising:
a generally tubular shaped body;
a first connecting end of said body arranged for releasably connecting with a complementary second connecting end for opening and closing the ring;
a series of lower locking teeth being laterally spaced and extending along the length of said first connecting end;
a series of upper locking teeth being laterally spaced and extending along the length of said second connecting end;
a first teeth receiving channel disposed at said first connecting end adjacent said lower locking teeth for receiving said upper locking teeth;
a second teeth receiving channel disposed at said second connecting end adjacent said upper locking teeth for receiving said lower locking teeth;
each said tooth of said lower locking teeth includes a hook portion extending overtop at least a portion of said first teeth receiving channel;
each said tooth of said upper locking teeth includes a hook portion extending overtop at least a portion of said second teeth receiving channel;
whereby said hook portion of said lower locking teeth engages said hook portion of said upper locking teeth when said first connecting end is directly overlapped with said second connecting end; and,
whereby a lateral displacement of said upper and lower locking teeth causes said first and second connecting ends to release.

15. The binder ring of claim 14 wherein each tooth of said lower locking teeth extends from a distal edge of said first connecting end to said first teeth receiving channel, and wherein each tooth of said upper locking teeth extends from a distal edge of said second connecting end to said second teeth receiving channel.

16. The binder ring of claim 15 wherein each said tooth of both said upper and lower locking teeth tapers upward from its respective distal edge and includes a convex top surface facilitating sliding of opposing teeth overtop each other when moving said first and second connecting ends into a connected arrangement.

17. The binder ring of claim 16 wherein said distal edge of said first connecting end aligns generally flush with an interior surface of said tubular shaped body when in a connected arrangement, and said distal edge of said second connecting end aligns generally flush with an exterior surface of said tubular shaped body when in a connected arrangement.

18. The binder ring of claim 14 including a series of release slots defined between adjacent teeth of said upper locking teeth and said lower locking teeth, wherein said upper locking teeth slide into said release slots between said lower locking teeth, and said lower locking teeth slide into said release slots between said upper locking teeth to release said first and second connecting ends when said lateral displacement is provided.

19. The binder ring of claim 14 wherein said hook portions of said upper and lower locking teeth include complementary angled engaging surfaces, wherein sliding engagement of said angled engaging surfaces between said upper and lower locking teeth when moving to a closed arrangement directs said lower locking teeth into said second teeth receiving channel and said upper locking teeth into said first teeth receiving channel.
